(19) United States
(12) Patent Application Publication
(10) Pub. No.: US 2007/0174880 A1
(43) Pub. Date: Jul. 26, 2007

(54) Method, apparatus, and system of fast channel hopping between encoded video streams

(75) Inventors: Lior Fite, Zurit (IL); David Sackstein, Kfar Saba (IL)

Correspondence Address: PEARL COHEN ZEDEK LATZER, LLP, 1500 BROADWAY 12TH FLOOR, NEW YORK, NY, 10036, US

(73) Assignee: OPTIBASE LTD.

(21) Appl. No.: 11/475,224

(22) Filed: Jun. 27, 2006

Related U.S. Application Data
(60) Provisional application No. 60/695,865, filed on Jul. 5, 2005.

(51) Int. Cl. H04N 7/173

(52) U.S. Cl. 725/87

(57) ABSTRACT

A method, apparatus, and system for rapid switching between encoded video streams while introducing a reduced amount of additional information during the switch. For example, a method of encoding uncompressed video frames in accordance with embodiments of the invention includes producing a first stream having a first key frame, a second key frame, and a delta frame therebetween; and producing a second stream having said first key frame, said second key frame, and a third key frame therebetween, wherein said third key frame corresponds with said delta frame. Other features are described and claimed.

### CROSS REFERENCE TO RELATED APPLICATION

This application claims priority from U.S. Provisional Application No. 60/695,865, filed on Jul. 5, 2005, the entire disclosure of which is incorporated herein by reference.

### FIELD OF THE INVENTION

The present invention relates to the field of streaming video. More specifically, the invention relates to rapid switching between video streams encoded with a temporal-redundancy encoding scheme supplemented by key frames. For example, a non-limiting list of such encoding schemes includes H.263, H.264, MPEG-4 part 2, MPEG-4 part 10, and the like.

### BACKGROUND OF THE INVENTION

Video compression may be desirable for reducing the required bandwidth for transmission of digital video data. For example, video compression may allow a broadcast service provider to transmit, e.g., high-definition television (HDTV) or multiple virtual channels using digital television formats such as, e.g., digital video broadcasting (DVB), Advanced Television Systems Committee (ATSC), Integrated Services Digital Broadcasting (ISBD), via a single physical channel. Video compression may also be desirable for streaming video, as it is known in the art, where video content is distributed over a computer network, for example, for use in an Internet Protocol Television (IPTV) system. A number of video and audio encoding standards are defined by the ISO/IEC Moving Pictures Experts Group (MPEG), including standards for video compression.

Some video encoding formats, including but not limited to, for example, H.263, H.264, MPEG-4 part 2, MPEG-4 part 10, and the like, include two main types of compressed frames: key frames and delta frames. A key frame may include substantially all of the data as the corresponding original frame while a delta frame may record only the differentiating data between frames. Thus, the original video data may be reconstructed independently from a key frame, but reconstruction of an image from a delta frame may depend on one or more previously received key frames. The achievable compression ratio for key frames is typically lower than the compression ratio for delta frames, therefore the use of key frames will usually increase the bandwidth required to attain a given video quality.

One method of reducing the bandwidth required to transport compressed video streams is to reduce the amount of key frames in the encoded video stream; that is by increasing the interval between consecutive key frame appearances. For example, many implementations of MPEG-2 encoding for television (TV) broadcast introduce key frames at least twice per second, although both MPEG-2 and MPEG-4 part 10 allow a lower frequency of key frames, e.g., one key frame every five seconds. However, as the receiving decoder may need to wait for a key frame before displaying a complete image, a reduction in key frame frequency may translate into longer frame reconstruction times and/or a longer channel hopping cycle when switching between multiple video stream channels.

One method of conserving bandwidth while maintaining a relatively short channel hopping cycle may be achieved through a tradeoff between video quality and frequency of key frame appearances. For example, PCT applications WO 2004/114667 A1 and WO 2004/114668 A1 (“Boyce et al.”), titled “Encoding Method and Apparatus Enabling Fast Channel Change of Compressed Video” and “Decoding Method and Apparatus Enabling Fast Channel Change of Compressed Video,” respectively, describe a normal video stream containing higher quality key frames at a lower frequency, multiplexed with a channel change stream containing lower quality key frames at a higher frequency. The higher frequency of key frames in the channel change stream of Boyce et al. may enable reducing the channel change delay by temporarily displaying lower-resolution video following a channel change event. However, the system of Boyce et al. requires reducing the bit rate of the normal video stream, or increasing the total bit rate of the channel in order to allow the insertion of the channel change stream. One or both of these operations are required throughout the delivery of the service, even when a channel change is not requested. A reduction of the video bitrate will cause a degradation of decoded video quality and an increase of the total bitrate may not be possible for excessive durations on a limited bandwidth network.

In the field of digital video broadcasting, e.g., digital cable and satellite television, it may be possible to reduce the delay in channel hopping without introducing additional key frames by creating short cached buffers of the received video streams, e.g., in the end-user decoder or in the digital subscriber line access multiplexer (DSLAM). Thus, the decoder may decode and display one video stream channel for viewing while other video stream channels are being decoded to a memory cache. Then, if the user desires to view a different channel than the currently displayed channel, the channel hopping cycle may be relatively short.

However, as it may not be not practical implement such caching for every channel, a simple heuristic may be used to predict the most likely candidate for the next channel hop. For example, the highest probability may be associated with the two adjacent channels in the channel number order presented to the viewer. Thus, if the user desires to switch to a non-adjacent channel, the desired channel may not be buffered and the problem of long delay in channel hopping remains. In addition, such a method may not be adequate for IPTV or on-demand services where video stream channels are not arranged in an adjacent manner. Caching methods suitable for IPTV video systems may require a more complicated technique to predict a viewer's channel change behavior. For example, one such method is described in US Patent Application Publication No. 2006/0075428 (Farmer et al.), titled “Minimizing Channel Change Time for IP Video”.

It is an object of embodiments of the invention, therefore, to provide for rapid switching between video streams encoded with a temporal-redundancy encoding scheme supplemented by key frames. It is a further object of some embodiments of the invention to provide for rapid switching between video streams without degrading the video quality or exceeding the total bandwidth when a channel change is not occurring.

### SUMMARY OF THE INVENTION

According to some embodiments of the invention, there is provided a method of producing streaming video, comprising producing a main video stream having a plurality of frames including key frames and delta frames therebetween; and producing a side video stream having substantially only a plurality of key frames, said producing based on analysis of said main video stream to determine frames to be encoded as key frames for insertion into said side stream.

According to some embodiments of the invention, there is provided a method of receiving streaming video, comprising during a subscriber channel viewing mode, receiving only a main video stream having a plurality of frames including key frames and delta frames therebetween; and during a subscriber channel change mode, receiving a said main stream and a side video stream having substantially only a plurality of key frames.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic diagram of a streaming video system according to some demonstrative embodiments of the invention;

FIG. 2 is a schematic diagram of streaming of a video channel having a main stream and a side stream according to some demonstrative embodiments of the invention;

FIG. 3 is a schematic diagram of a sequence of operation of a video encoder to create video streams according to some demonstrative embodiments of the invention;

FIG. 4 is a schematic diagram of a video encoding system to create video streams according to some demonstrative embodiments of the invention;

FIG. 5 is a schematic flowchart diagram of a sequence of operation of a decoder to switch streaming video channels according to some demonstrative embodiments of the invention; and

FIG. 6 is a schematic diagram of merging of video streams according to some demonstrative embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical. Such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be appreciated that according to some embodiments of the present invention, the method described below may be implemented in machine-executable instructions. These instructions may be used to cause a general-purpose or special-purpose processor that is programmed with the instructions to perform the operations described. Alternatively, the operations may be performed by specific hardware that may contain hardwired logic for performing the operations, or by any combination of programmed computer components and custom hardware components.

The method may be provided as a computer program product that may include a machine-readable medium having stored thereon instructions that may be used to program a computer (or other electronic devices) to perform the method. For the purposes of this specification, the terms “machine-readable medium” may include any medium that is capable of storing or encoding a sequence of instructions for execution by the machine and that cause the machine to perform any one of the methodologies of the present invention.

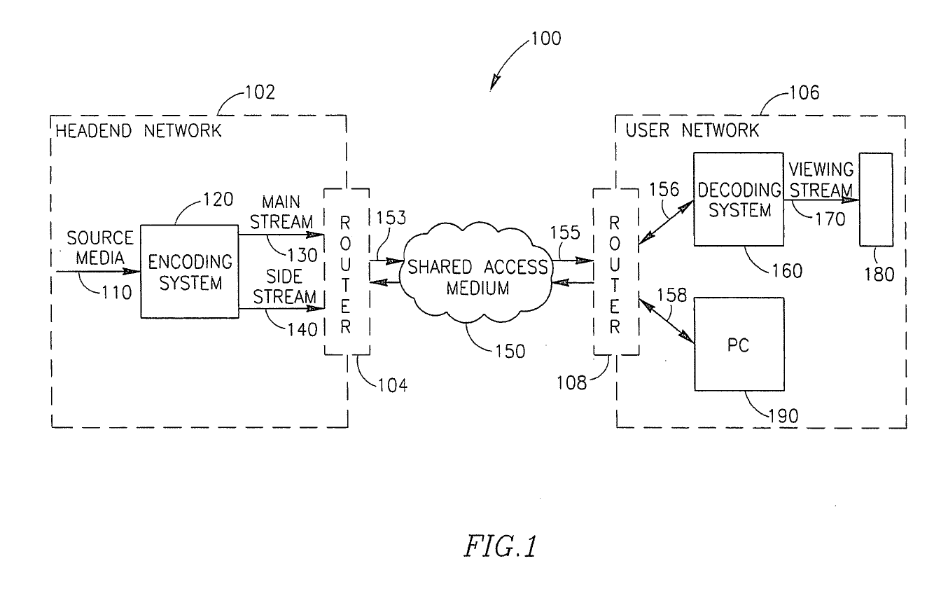

Reference is made to FIG. 1, which schematically illustrates a system 100 of streaming video according to some demonstrative embodiments of the invention. Although embodiments of the invention are not limited in this respect, streaming video system 100 may include an encoding system 120 to encode original data signals 110, which may include, e.g., video and audio signals, and a decoding system 160 to decode the bitstream and produce a viewing stream 170 of reconstructed video and audio signals for viewing on a user system 180. The encoded bitstream may be communicated from the encoding system to the decoding system via a shared access medium or distribution network 150.

Streaming video system 100 may include an encoding system 120 to encode source media 110, which may include, e.g., video and audio signals. In some embodiments, encoding system 120 may be included in a headend network 102, as known in the art. Headend network 102 may include a router 104, as known in the art, which may help arbitrate communication 153 to/from the headend network, as explained in more detail below. For example, during normal viewing of a channel, router 104 may transmit only a main stream 130 of the channel to be included in traffic 153. At other times, for example, in response to a received signal or request, router 104 may transmit in traffic 153 both the main stream 130 of a requested channel and an associated sidestream 140 of that channel, e.g., to reduce the channel hopping delay, as explained in more detail below.

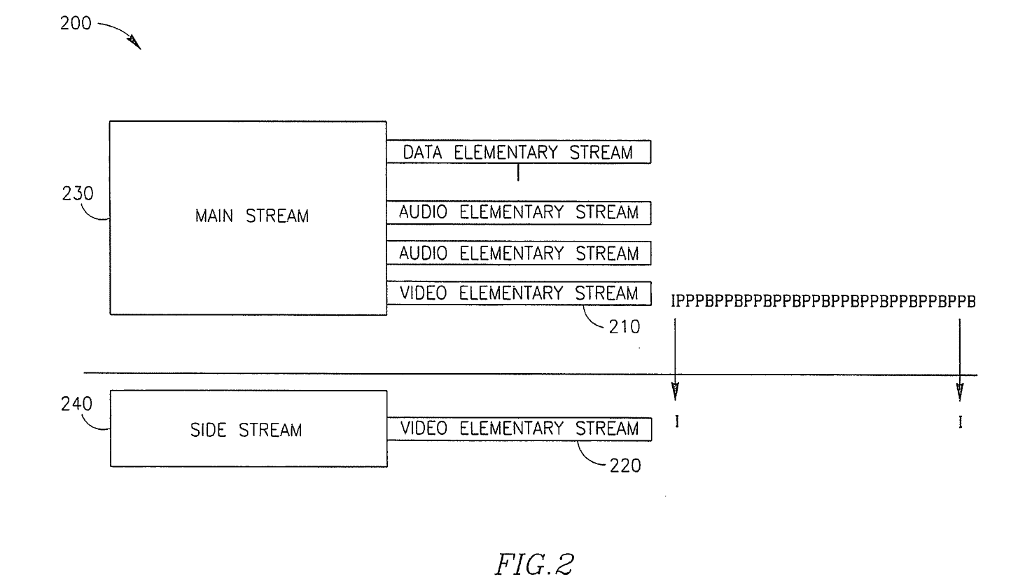

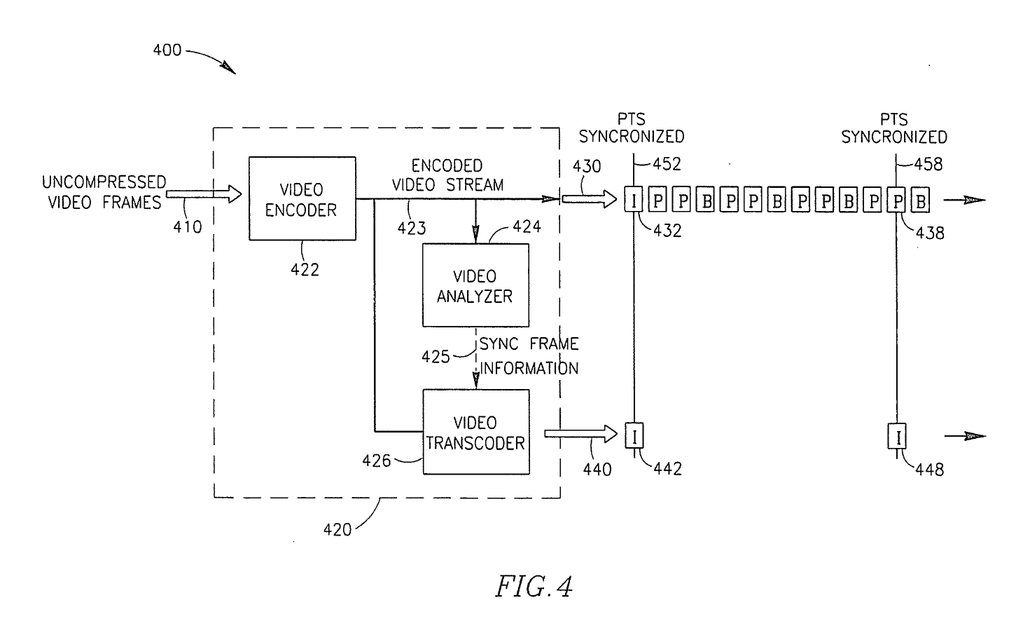

Although embodiments of the invention are not limited in this respect, encoding system 120 may include, for example, one or more general-purpose processors, e.g., a Central Processing Unit (CPU), to run encoding software; one or more dedicated or special-purpose processors, e.g., a Digital Signal Processor (DSP) to run encoding software, e.g., an MPEG integrated circuit; an entire solution integrated on chip with hardware macros to run the encoders; or any combination of hardware and/or software suitable for encoding digital video streams, as is known in the art. According to some demonstrative embodiments of the invention, encoding system 120 may produce a pair of video streams, including a main stream 130 and an associated side stream 140, based on the source media 110, as explained in more detail below with reference to FIGS. 2-4. For example, an encoding system in accordance with some demonstrative embodiments of the invention is described in detail below with reference to FIG. 4.

Streaming video system 100 may include a decoding system 160 to decode the bitstream 156 and produce a viewing stream 170 of reconstructed video and audio signals for viewing on a user system 180. In some embodiments, decoding system 160 may be included in a user network 106, e.g., a local area network (LAN) or wireless local area network (WLAN). User network 106 may include a router 108, as known in the art, which may help arbitrate communication 155 to/from the user network. For example, router 108 may receive data traffic 155 from the shared access medium including the encoded video stream or streams corresponding to source media 110, e.g., main stream 130 and/or sidestream 140, as well as additional data traffic intended for other devices in user network 106, e.g., Internet traffic 158 for a personal computer (PC) 190. Router 108 may direct the encoded video stream 156 to decoding system 160 and any additional data traffic 158 to the appropriate device, e.g., PC 190.

In some embodiments, decoding system 160 may include, for example, a processor, a memory unit, and a decoder, as are known in the art. For example, decoding system 160 may be implemented as a System-On-Chip. According to some demonstrative embodiments of the invention, decoding system 160 may include a set-top box (STB) associated with a television set or video receiver in user system 180. Alternatively, user system 180 may include a personal computer (PC), and decoding system 160 may be implemented using hardware, software, or a suitable combination of hardware and software therein.

Shared access medium 150 may include or may be, for example, any distribution network capable of streaming IP/UDP multicast packets, as is known in the art. For example, shared access medium 150 nay include multiple routers and/or switches, as known in the art, and multiple interconnected subnets. Streams 130 and 140 may be transmitted using appropriate transport protocols, e.g., multicast channels stream format, video transport stream over UDP/IP (User Datagram Protocol/Internet Protocol), video elementary stream over RTP/UDP/IP (Real Time Protocol/User Datagram Protocol/Internet Protocol), or any other protocol or format and/or combination thereof as is known in the art that may allow decoding system 160 to receive or stop receiving the transmitted data. For example, decoding system 160 may use an upstream Internet Group Management Protocol (IGMP) “join” signal, as known in the art, to request transmission of a particular main stream or sidestream, and may use an IGMP “unjoin” signal, as known in the art, to request that the stream or streams no longer be transmitted.

It will be appreciated that headend router 104 may at times, e.g., during normal viewing mode, transmit only main stream 130 to user router 108; at other times, e.g., during channel hopping mode or substantially during a channel change event, headend router 104 may transmit both mainstream 130 and sidestream 140 to user router 108. Thus, although embodiments of the invention are not limited in this respect, bitstream 156 to the decoding system may use less bandwidth during normal viewing mode than during a channel change event. Any bandwidth thus conserved may, for example, be used to increase the available bandwidth for data traffic 158.

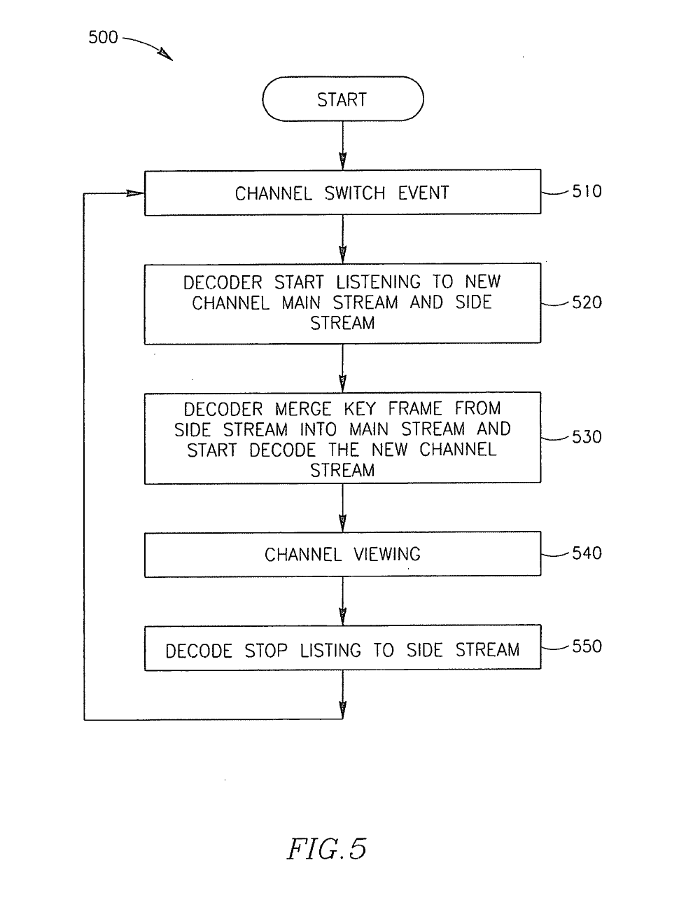

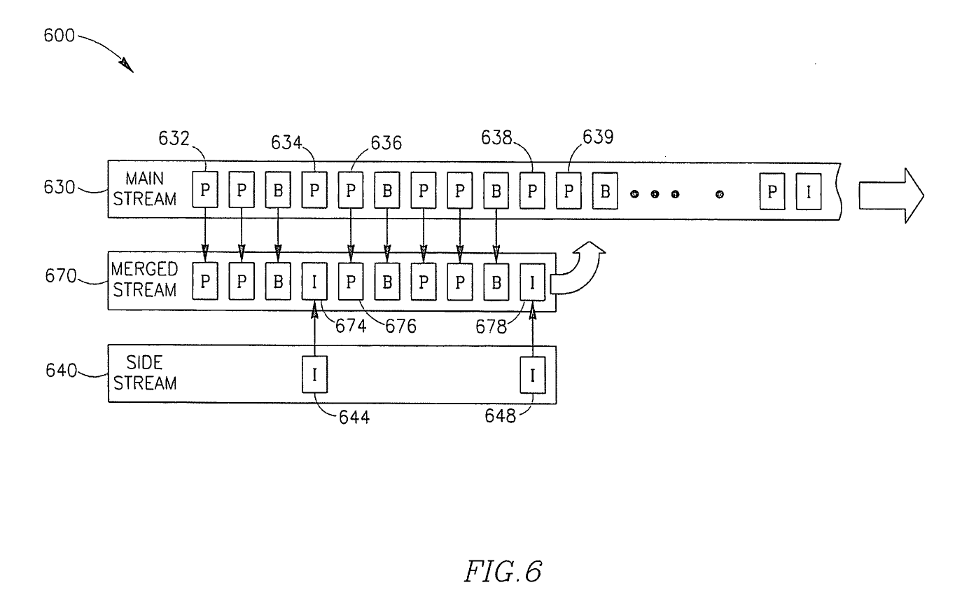

Although embodiments of the invention are not limited in this respect, the main stream 130 and associated side stream 140 may represent a virtual channel of media content corresponding to source media 110. For example, the content channel may be multicast over network 150 to a plurality of end-users, including, e.g., a user of system 180. Decoding system 160 may receive multiple streaming video channels via network 150 and may, e.g., decode them one at a time to produce viewing stream 170 for viewing on user system 180. A method of switching between video streams is described in detail below with reference to FIG. 5. Creation of a merged viewing stream is described in detail below with reference to FIG. 6.

Reference is made to FIG. 2, which is a schematic illustration of streaming of a video channel 200 having a main stream and a side stream according to some demonstrative embodiments of the invention. Although embodiments of the invention are not limited in this respect, streaming video channel 200 may correspond to the bitstream produced by encoding system 120 of FIG. 1 based on source media 110. Content channel 200 may include a main stream 230 and a side stream 240, which may correspond to main stream 130 and side stream 140 of FIG. 1, respectively.

Although embodiments of the invention are not limited in this respect, main stream 230 may include multiple elementary streams to encode different aspects of the original source media, e.g., one or more video, audio, and data elementary streams to support, for example, multiple language soundtracks and/or subtitles or additional camera angles. For example, the multiple elementary streams may be multiplexed into a transport stream, as is known in the art. In accordance with embodiments of the invention, at least one video elementary stream in main stream 230, e.g., video elementary stream 210 may correspond to a video elementary stream in side stream 240, e.g., video elementary stream 220, as explained in detail below.

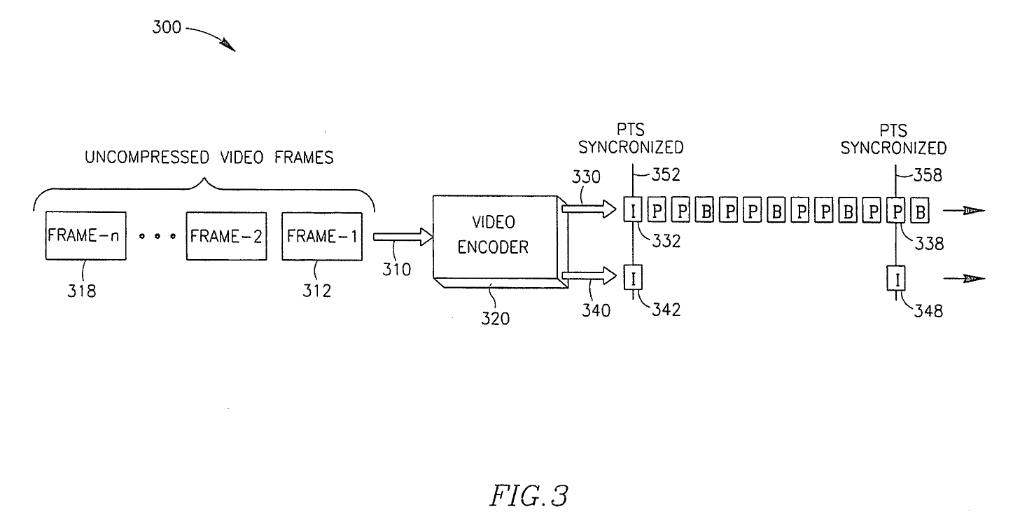

According to some demonstrative embodiments of the invention, video stream 210 of main stream 230 may include compressed frames encoded with a key frame redundancy encoding scheme, e.g., MPEG-4 part 10, having key frames at a relatively low frequency of occurrence, e.g., once every five seconds. Video stream 220 of side stream 240 may include key frames corresponding to, or derived from the main stream 230. In some embodiments, the key frames may appear in the side stream at a higher frequency of occurrence relative to the key frames in video elementary stream 210, e.g., once every second, or it may be the same as in the main stream. As described more fully herein, in some embodiments of the invention, the occurrence of key frames in the side stream may be calculated to result in less channel change delay at the receiving side. In accordance with demonstrative embodiments of the invention, the key frames of the side stream may be synchronized to the main stream by means of timing markers such as, for example, Decoding Time Stamp (DTS) or Presentation Time Stamp (PTS), as known in the art. The composition of the frames in streams 210 and 220 in accordance with demonstrative embodiments of the invention is explained in detail below with reference to FIG. 3.

Reference is made to FIG. 3, which schematically illustrates a sequence of operation 300 of a video encoder 320 to create video streams according to some demonstrative embodiments of the invention. Although embodiments of the invention are not limited in this respect, video encoder 320 may correspond to components of encoding system 120 of FIG. 1. In accordance with demonstrative embodiments of the invention, video encoder 320 may encode uncompressed video frames 310, using, e.g., H.263, H.264, MPEG-4 part 2, MPEG-4 part 10, or similar encoding formats as known in the art, to produce an output of two parallel video streams, e.g., a main stream 330 and a side stream 340, having compressed frames corresponding to the source video frames 310. Although embodiments of the invention are not limited in this respect, main stream 330 and side stream 340 may correspond to main stream 130 and side stream 140 of FIG. 1, respectively.

For example, the MPEG-4 video compression standard defines three possible types of compressed frames: intra-frame (I frame), predicted frame (P frame), and bi-directional frame (B frame). As known in the art, an I frame is a key frame encoded without reference to anything except itself. I frames may be decoded independently and may be required for decoding of successive frames. P frames and B frames are two types of delta frames. P frames may contain changes from previous or future frames and B frames may contain references to both previous and next frames. In addition, the MPEG standards include timing markers, e.g., PTS and DTS timestamps, which may be entered into an encoded bitstream to synchronize between the encoder and a decoder, e.g., by instructing the decoder when to present the video/audio data.

According to some demonstrative embodiments of the invention, encoder 320 may encode a first source frame, e.g., frame 312, to produce an I frame 332 of main stream 330 and an I frame 342 of side stream 340. Encoder 320 may encode successive source frames to produce delta frames, e.g., P frames and B frames, of main stream 330. In addition, encoder 320 may encode a source frame, e.g., frame 318, to produce a P frame 338 of main stream 330 and an I frame 348 of side stream 340. Thus, the main stream may include compressed frames corresponding to all source frames 310, whereas the side stream may include compressed key frames corresponding to a partial set of the source frames 310, with key frames appearing at a higher rate relative to those in main stream 330. In accordance with demonstrative embodiments of the invention, the key frames of side stream 340 may be synchronized to mainstream 330 with timing markers, e.g., PTS time stamps 352 and 358. For example, PTS 358 may indicate to a decoder that P frame 338 of the main stream and I frame 348 of the side stream are to be presented to the user at the same time, corresponding to the timing of source frame 318. It will be noted that in some embodiments of the invention, key frames may be produced at times calculated to reduce channel change delay at the receiving end. For example, in some embodiments, encoder 320 may produce a key frame in the side stream 340 at one or more elapsed times after production of a key frame in the main stream 330.

Reference is made to FIG. 4, which schematically illustrates a video encoding system 420 creating video streams according to some demonstrative embodiments of the invention. Although embodiments of the invention are not limited in this respect, encoding system 420 may be an example of encoding system 320 of FIG. 3 and/or encoding system 120 of FIG.

Encoding system 420 may encode uncompressed video frames 410 to produce two parallel video streams, e.g., a main stream 430 and a side stream 440. Side stream 440 may include I frames, e.g., I frames 442 and 448, corresponding to frames of main stream 430, e.g., I frame 432 and P frame 438, respectively. Main stream 430 and side stream 440 may be synchronized with timing markers, e.g., PTS timestamps 452 and 458.

According to some demonstrative embodiments of the invention, encoding system 420 may be able to dynamically control the creation of I frames in side stream 440 based on certain optimization parameters, for example, such that the bitrate of the side stream is minimized. For example, encoding system 420 may include an encoder 422, an analyzer 424, and a transcoder 426. Elements of encoding system 420 may be implemented using hardware, software, or any suitable combination of hardware and/or software as is known in the art.

In some embodiments, encoder 422, e.g., a general- or special-purpose processor running encoding software, may be configured to create an encoded video stream 423 using a GOP (Group Of Pictures) structure, e.g., as defined in the MPEG-2 standards. As is known in the art, a GOP structure may define a sequence of frames in a specified order, beginning with an I frame and preceded by a GOP header, which may include syntax such as timing information, editing information, optional user data, and the like. The ratio of I frames, P frames, and B frames in the GOP structure may be determined by parameters such as, for example, the nature of the video stream, the bandwidth constraints on the output stream, and encoding time. The length of the GOP structure may define the period between consecutive I frame appearances.

Although embodiments of the invention are not limited in this respect, encoded stream 423 may be output from encoding system 420 as main stream 430. In addition, video analyzer 424 may tap or analyze the encoded video stream 423 created by video encoder 422 and determine which frame or frames of the main stream may be best suited for encoding as an I frame in side stream 440.

In accordance with some demonstrative embodiments of the invention, video analyzer 424 may analyze the content and encoding decisions made by encoder 422 and signaled in the encoded stream 423 to determine optimal intervals between two consecutive I frames in the side stream, e.g., in order to enable a fast channel change time while introducing as few I frames as possible in side stream 440. For instance, analyzer 424 may introduce an I frame where it has determined that a scene change has occurred in the uncompressed video frames 410, or, conversely, it may decide not to introduce an I frame at a scene change because the encoder 422 has already done so. Combinations of considerations are possible, for example, analyzer 424 may introduce an I frame within a predetermined time after a scene change if the encoder has not done so. It will be appreciated that the embodiments of the invention are not limited to these particular decisions by analyzer 424.

According to some demonstrative embodiments of the invention, video analyzer 424 may provide frame synchronization information in an output signal 425 to video transcoder 426. For example, the frame synchronization information may indicate which frames of encoded video stream 423 are to be re-encoded as I frames of the side stream 440, along with timing information of those frames. In some embodiments, based on the output of analyzer 424, video transcoder 426 may re-encode one or more P frames and/or B frames from encoded video stream 423 to produce one or more I frames of side stream 440. In addition, video transcoder 426 may insert timing markers to synchronize the re-encoded I frames of side stream 440 with the corresponding encoded frames of main stream 430. In alternative embodiments, the functionality of transcoder 426 may be performed by encoder 422. In such an embodiment, output signal 425 from analyzer 424, including the frame synchronization information, may be provided to the encoder 422.

Reference is made to FIG. 5, which is a schematic flowchart illustration of a method 500 which may be performed by a decoder to switch streaming video channels according to some demonstrative embodiments of the invention. Although embodiments of the invention are not limited in this respect, method 500 may be performed by components of decoding system 160 of FIG. 1.

As indicated at block 510, method 500 may correspond to the decoding system may receive a channel change event, e.g., initiated by a user. Although embodiments of the invention are not limited in this respect, method 500 may correspond to a channel hopping mode and may be performed substantially during a channel change event. As indicated at block 520, the decoding system may start monitoring the main stream and the side stream of the requested channel while still displaying the current channel. For example, the decoding system may send an upstream IGMP join request, as known in the art, or any other indication signal suitable for requesting transmission of the main stream and the side stream of tie new channel. As indicated at block 530, the decoding system may merge key frames from the side stream into the main stream to create a merged stream for decoding and producing therefrom a reconstructed viewing stream. A merged stream in accordance with some demonstrative embodiments of the invention is described in detail below with reference to FIG. 6.

As indicated at block 540, the decoding system may decode and display the merged stream to allow channel viewing by the user. In accordance with demonstrative embodiments of the invention, the elapsed time between receiving the channel change event (block 510) and displaying the requested channel for viewing (block 540) may depend on the rate of the key frames included in the side stream, rather than on the rate of key frames included in the main stream. Thus, demonstrative embodiments of the invention may enable a faster channel-hopping cycle between video streams.

Although embodiments of the invention are not limited in this respect, as indicated at block 550, the decoding system may stop monitoring the side stream after a key frame from the merged stream is decoded. For example, the decoding system may send an IGMP unjoin request, as known in the art, or any other indication signal suitable for requesting that transmission of the side stream be discontinued. Alternatively, in some embodiments the decoding system may join the side stream for a predetermined period of time sufficient to allow decoding of a first key frame from the merged stream, and subsequently leave the side stream automatically. The decoding system may continue to decode compressed video frames from the main stream in normal viewing mode until receiving an additional channel change event.

Reference is made to FIG. 6, which schematically illustrates creating a merged video stream 670 according to some demonstrative embodiments of the invention. Although embodiments of the invention are not limited in this respect, merged stream 670 may correspond to viewing stream 170 produced by decoding system 160 of FIG. 1. For example, merged stream 670 may be created by merging a main stream 630, e.g., corresponding to main stream 130 of FIG. 1, and a side stream 640, e.g., corresponding to side stream 140 of FIG. 1. It will be appreciated that a merged stream, as described herein, may refer to a new stream produced from the main stream and side stream for decoding as a viewing stream.

In accordance with demonstrative embodiments of the invention, the decoder may insert delta frames from the main stream, e.g., a P frame 632, into merged stream 670, e.g., in the position of frame 672. The decoder may merge key frames from the side stream, e.g., I frame 644, into merged stream 670, e.g., in the position of frame 674. Although embodiments of the invention are not limited in this respect, key frame 544 may correspond to a delta frame in main stream 630, e.g., P frame 634. The decoder may continue to merge a next delta frame from main stream 630 into merged stream 670, e.g., P frame 636 into position 676, which may follow the position of frame 674.

According to some demonstrative embodiments of the invention, side stream 640 may be synchronized with main stream 630 by means of clear timing markers, which may allow the decoder to merge the two streams correctly, i.e., to insert key frame 644 of the side stream in position 674 and to insert the next delta frame 636 of the main stream in the next position 676. For example, when encoding, the encoding system, e.g., encoding system 120 of FIG. 1, may insert timing markers on the streaming transport wrapping format, e.g., using RTP user-defined fields in RTP format or PTS and DTS timestamps in an MPEG video stream format.

According to some demonstrative embodiments of the invention, as stated above with reference to FIG. 4, the decoder may discontinue merging main stream 630 and side stream 640 after a first key frame of merged stream 670 is decoded, e.g., I frame 678. After decoding key frame 678, the decoder may continue to decode the next delta frame of main stream 630, i.e., frame 639. In accordance with demonstrative embodiments of the invention, the decoded result of delta frame 638 and the decoded result of key frame 678 may be sufficiently similar as to enable the decoder to decode frame 639 using key frame 678 instead of the previous delta frame 638. Similarly, all frames in the merged stream 670 may be decoded based on the side stream key frames.

It will be understood that many benefits of using various embodiments of the present invention will be understood by those of skill in the art. For example, in a limited bandwidth environment, using embodiments of the invention, by conserving bandwidth used by transmitting signal 156, more bandwidth may be allocated to signal 158.

Embodiments of the present invention may be implemented by software, by hardware, or by any combination of software and/or hardware as may be suitable for specific applications or in accordance with specific design requirements. Embodiments of the present invention may include modules, units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. A method of producing streaming video, comprising:
producing a main video stream having a plurality of frames including key frames and delta frames therebetween; and
producing a side video stream having substantially only a plurality of key frames, said producing based on analysis of said main video stream to determine frames to be encoded as key frames for insertion into said side stream.

2. The method of claim 1, wherein said analysis includes detecting an elapsed period in said main stream without a key frame.

3. The method of claim 1, wherein said analysis includes producing key frames in said side stream at a side stream key frame frequency greater than a main stream key frame frequency.

4. The method of claim 1, wherein producing said side video stream comprises producing a key frame in said side stream based on at least one key frame and at least one delta frame of said main stream based on said analysis.

5. The method of claim 1, wherein producing said side video stream comprises encoding at least one frame to produce one or more key frames of said side stream based on said analysis.

6. The method of claim 1, wherein said main stream and said side stream are synchronized with timing markers based on the timing of source frames.

7. The method of claim 7, wherein one or more of said timing markers comprise a presentation time stamp.

8. The method of claim 7, wherein one or more of said timing markers comprise a decoding time stamp.

9. The method of claim 1, further comprising transmitting said main stream using multicast over the Internet Protocol.

10. The method of claim 1, further comprising transmitting said side stream using multicast over the Internet Protocol.

11. A method of receiving streaming video, comprising:
during a subscriber channel viewing mode, receiving only a main video stream having a plurality of frames including key frames and delta frames therebetween; and
during a subscriber channel change mode, receiving a said main stream and a side video stream having substantially only a plurality of key frames.

12. The method of claim 11, comprising:
initiating said channel change mode upon receiving a change channel request by the subscriber.

13. The method of claim 12, wherein said main stream is multicast over the Internet Protocol.

14. The method of claim 12, wherein said side stream is multicast over the Internet Protocol.

15. The method of claim 12, wherein receiving only a main video stream is initiated by sending a multicast join signal.

16. The method of claim 12, comprising:
terminating said channel change mode upon receiving an unjoin signal.

17. The method of claim 12, comprising:
terminating said channel change mode a predetermined time after initiating said channel change mode.

18. The method of claim 17, comprising reverting to said channel viewing mode after termination of said channel change mode.

19. The method of claim 12, comprising:
creating a merged stream from said main stream and said side stream by merging at least one key frame from said side stream into said main stream.

20. The method of claim 19, comprising decoding frames of said merged stream for viewing.
